(19) United States
(12) Patent Application Publication
(10) Pub. No.: US 2003/0163716 A1
(43) Pub. Date: Aug. 28, 2003

(54) Card key security system and method

(76) Inventors: Mark Nelson Robins, Greeley, CO (US); Heather Noel Bean, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/086,354

(22) Filed: Feb. 28, 2002

(51) Int. Cl. H04L 9/00

(52) U.S. Cl. 713/193

(57) ABSTRACT

A system and method for preventing unauthorized use of a digital camera is provided. The digital camera has a security file, the security file acts as a password. The system may be a program stored as a computer readable medium, the program comprising: logic configured to prompt a user to provide a card key, the card key including the password; logic configured to retrieve data from the card key, the logic configured to retrieve data including logic for interfacing with a memory module card of a digital camera; logic configured to determine whether the data from the card key includes the password; logic configured to enable the use of the digital camera if the data from the card key includes the password; and logic configured to disable the digital camera if the data from the card key does not includes the password.

### TECHNICAL FIELD

The present invention is generally related to property anti-theft technology and, more particularly, is related to a system and method for preventing the unauthorized use of electronic devices.

### BACKGROUND OF THE INVENTION

Digitally based image capturing devices capture images. The captured image or “photograph” of an object is stored in a digital data format in the memory within, or coupled to, the image capturing device. A nonlimiting example of a digital image capturing device is the digital camera that captures still images and/or video images. As with many types of electronic devices, digital cameras are relatively expensive. Digital cameras are thus a target of thieves.

Similarly, many other electronic devices are the target of thieves. For example, but not limited to, a personal computer (personal computer), a lap top computer or a personal digital assistant (PDA) is a relatively small and easily stolen electronic device.

Electronic device owners would benefit from a system and method that would decrease the value of the electronic device in the hands of a thief, while maintaining the value of the electronic device for the owner. Physical keys have been used to decrease the value of electronic device in the hands of a thief who does not possess the key. That is, the electronic device is unusable unless the user is in possession of a valid key.

Such hardware devices are plugged into, or coupled to, the electronic device for the electronic device's software to operate. One example of such a hardware device, or key, is known as a “dongle.” However, a physical key and/or other hardware device may be lost by owners or authorized users and thus result in a loss of value and/or a great inconvenience for the owner since the device cannot be operated without the physical key.

Furthermore, if the electronic device is stolen with the physical key and/or other hardware device, the thief will be able to operate, and presumably sell to another party, the electronic device. Thus, the purpose of the physical key is defeated if the thief also obtains the key.

### SUMMARY OF THE INVENTION

The present invention provides a system and method for preventing the unauthorized use of an electronic device. Briefly described, in architecture, one embodiment of the system comprises a security file corresponding to a predefined security code, a memory residing in the electronic device and configured to store the security file, a card key corresponding to the predefined security code, a processor configured to compare the card key with the security file, and a security timer configured to time a period of time such that the processor compares the card key with the security file after the time period has elapsed. The processor is further configured to enable use of the electronic device only if the data corresponding to the captured image corresponds to the card key.

### BRIEF DESCRIPTION OF THE DRAWINGS

The components in the drawings are not necessarily to scale relative to each other. Like reference numerals designate corresponding parts throughout the several views.

FIG. 1 is a block diagram of an embodiment of a digital camera system according to the present invention, including a digital camera, a personal computer and a memory card.

FIG. 2 is a block diagram of an embodiment of the digital camera of FIG. 1 having a memory element storing a card key security system and a security timer according to the present invention.

FIG. 3 is a flowchart of an embodiment of the card key security system of FIG. 2.

FIG. 4 is a block diagram of an embodiment of the digital camera of FIG. 1 having a memory element storing a card key security system according to the present invention.

### DETAILED DESCRIPTION

The present invention provides a system and method for preventing the unauthorized use of property, such as, but not limited to, an electronic device, a personal computer (personal computer), a digital camera, a lap top computer, or a personal digital assistant (PDA). The present invention uses a security file residing in a memory module of a digital camera. The security key acts as a password that enables use of the camera. One embodiment of the present invention executes a program for comparing a card key with the security file. Among other devices, the card key may be stored in a memory module unit and/or a personal computer. If the card key is not provided to the property, the system for preventing the unauthorized use of the property disables the property.

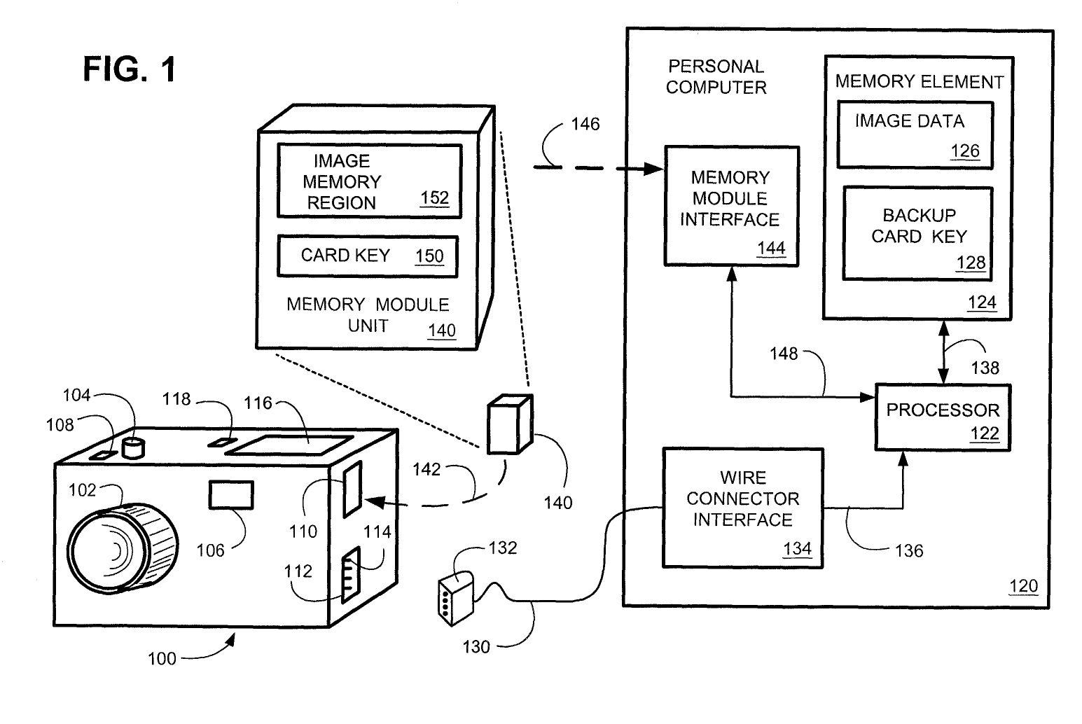

For convenience of teaching the components, operation and functionality of the present invention, the present invention is described as being implemented in, or being a part of, a digital camera 100 (FIG. 1). One embodiment of the present invention is equally applicable in any electronic device configured to operate with a modular, insertable component, such as, but not limited to, a memory medium. For example, but not limited to, a personal computer, lap top computer or personal digital assistant (PDA) configured to couple to or receive a memory medium are alternative embodiments of the present invention. For example, one embodiment is implemented as a personal computer configured to couple to or receive a memory module, such as, but not limited to, a floppy disc, a compact disc (CD), a compact flush (CF) card, a personal computer card, a mini-compact disk or the like. Thus, the present invention is incorporated to operate in conjunction with any such type of electronic device.

FIG. 1 is a block diagram of a digital camera system according to the present invention having a system for preventing the unauthorized use of digital camera 100. Digital camera 100 further includes at least a lens unit 102, an image capture actuation button 104, a viewing lens 106, a power switch 108, a memory unit interface 110, and a plug-in interface unit 112. Plug-in interface unit 112, in one embodiment, includes a plurality of connection pins 114. A display 116 is used for previewing images prior to capturing or for viewing captured images. For convenience of illustration, display 116 is illustrated on the top of the digital camera 100.

Operation of digital camera 100 is initiated by actuation of power switch 108 or an equivalent device having the same functionality When digital camera 100 is turned on, display 116 typically remains off so as to conserve limited battery power of digital camera 100. Actuation of a suitable controller device, such as, but not limited to, control button 118, turns on display 116 such that the user (not shown) of digital camera 100 may view an image detected through lens unit 102. Alternatively, an image of a previously captured image or a menu screen may be initially displayed. In an alternative embodiment, other buttons, switches or control interface devices are additionally configured to turn on display 116 when actuated.

Lens unit 102 is a well-known device used for the focusing of the image. When the operator has focused the image to be captured and is satisfied with the nature of the image that will be captured by digital camera 100, the operator actuates image capture actuation button 104 (also referred to as a shutter button or a shutter release button) to cause digital camera 100 to record a digital image, thus “photographing” the image. The operator of digital camera 100 may visually preview the image before capturing the image on display 116 and/or view the image directly through viewing lens 106.

FIG. 1 further illustrates a personal computer 120 that is typically employed with digital cameras such that digital images captured by the digital camera 100 may be retrieved, processed, printed and/or e-mailed. Personal computer 120 includes at least a processor 122 and a memory element 124. Memory 130 further includes at least an image data region 126 and a backup card key 128. Retrieved image data from digital camera 100 is stored in the image data region 126. Backup card key 128 is stored data configured to function as a password, security code, personal identification code (PIN), or other suitable identifier that corresponds to a string of alpha-numeric characters or another suitable code, such as binary, hexadecimal or similar coding systems.

In one embodiment, digital camera 100 transfers captured images to personal computer 120, via connection 130. Connection 130 may be any suitable connector, such as, but not limited to, a universal serial bus (USB), serial, parallel connection, or the like. Alternatively, a wireless transfer medium can be employed, such as, but not limited to, radio frequency and infrared. In one embodiment employing a hardwire connection, connection 130 is coupled to the plug-in attachment 132, or another suitable coupler. Plug-in attachment 132 is configured to mate with plug-in interface unit 112. The user of personal computer 120 and digital camera 100 simply mates plug-in attachment 132 into plug-in interface 120, thereby establishing connectivity between digital camera 100 and personal computer 120. The user instructs the exemplary embodiment of personal computer 120, and/or digital camera 100, to execute logic causing digital images to be transferred from digital camera 100 through wire connector interface 134, connection 136, processor 122, connection 138, and then into the image data region 126 of memory 130.

In an embodiment of digital camera 100, digital image data is stored in memory module unit 140. When capturing images with digital camera 100, memory module unit 140 is coupled to digital camera 100 through memory unit interface 110, as illustrated by the path of insertion represented by dashed line 142. Memory module unit 140 may be formatted in various ways, such as, but not limited to, a standard computer disk, a floppy disc, a compact disk (CD), a mini-compact disk, or other suitable memory medium. Formatting memory module unit 140 as a memory medium allows for simple interfacing with personal computer 120.

Digital image data is transferred to personal computer 120 by removing memory module unit 140 from digital camera 100 and coupling memory module unit 140 to memory module interface 144, as illustrated by the path of insertion represented by dashed line 146. Typically, a convenient coupling port or interface (not shown) is provided on the surface of personal computer 120 such that memory module unit 140 is directly coupled to personal computer 120. Once memory module unit 140 is coupled to personal computer 120, digital image data is transferred through memory module interface 144, connection 148, processor 122, connection 138, and then into the image data region 126 of memory 130.

For convenience, digital camera 100 is illustrated as employing both a plug-in interface 120 configured to couple to a physical connector and a memory unit interface 110 configured to receive memory module unit 140. Other embodiments of digital camera 100 employ either plug-in interface 120 or a memory unit interface 110 to facilitate the transfer of captured images to personal computer 120.

For convenience, personal computer 120 is illustrated as having only selected components of interest. However, personal computer 120 includes additional internal components not illustrated in FIG. 1. Digital camera 100 also includes additional components not shown in FIG. 1.

In one embodiment, memory module unit 140 includes a card key 150 and an image memory region 152. Preferably, the card key 150 is a hidden file and/or a protected file. Accordingly, an unauthorized person cannot easily make a copy of card key 150.

Prior to using digital camera 100, memory module unit 140 is coupled to the personal computer 120. The user selects a secret code that is stored onto the card key 150 and the backup card key 128. As described above, this secret code is configured to function as a password, security code, personal identification code (PIN), or other suitable identifier. Once the user has selected the secret code and communicated it to personal computer 120, processor 122 stores the secret code into the memory element 124 as backup card key 128, and also communicates the secret code to memory module unit 140, via the memory module interface 144, for storage as card key 150. Card key 150 is typically stored as a hidden and/or protected file, thereby preventing transference to another memory module unit 140. One embodiment includes information unique and specific to the memory module unit 140, such as, but not limited to, serial number or manufacture date, so that the card key 150 becomes specific to the memory module unit 140. Thus, the card key 150 cannot be copied into a different memory module unit. Software for creating card key 150 and backup card key 128 may be included with computer software supplied with digital camera 100, provided with personal computer 120, and/or provided separately.

When the user couples memory module unit 140 to digital camera 100, digital camera 100 compares card key 150 with the security file 218, as described in greater detail below, to determine if the individual attempting to use digital camera 100 is an authorized user. If the memory module unit is not coupled to digital camera 100, or if card key 150 does not correspond to an authorized security code, digital camera 100 is disabled and will not operate.

Accordingly, embodiment of digital camera 100 employing the present invention is configured to store captured image data in a memory module unit 140. Thus, card key 150 is not visible or easily detected by a thief or other unauthorized user. Such a thief or other unauthorized user would need access to both digital camera 100 and memory module unit 140 to use digital camera 100. Accordingly, the thief has to know that memory module unit 140 must be coupled to digital camera 100 for activation of digital camera 100. Thus, a digital camera 100 that is rendered inoperable in accordance with the present invention has little or no value to a thief or other unauthorized user, and accordingly becomes less desirable.

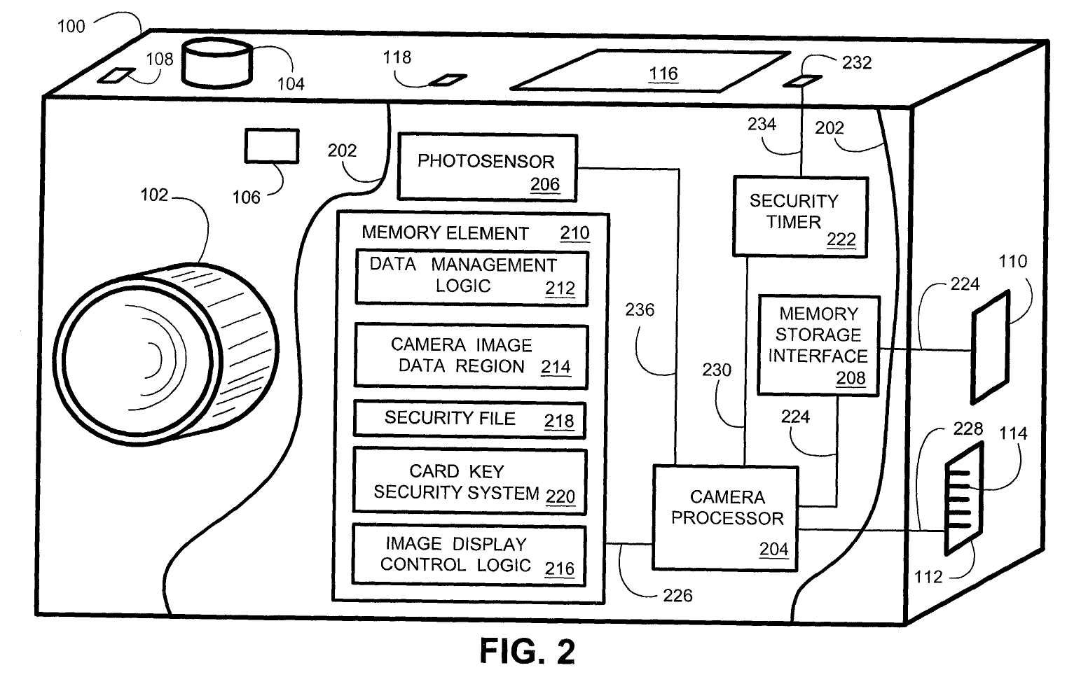

FIG. 2 is a block diagram of an embodiment of digital camera 100. Cut-away lines 202 demark components residing on the outside surfaces of the digital camera 100 and components residing internally in the digital camera 100. Thus, the control button 118, lens unit 102, image capture actuation button 104, power switch 108, memory unit interface 110, plug-in interface 120 and display 116 are recognized as components residing on the surfaces of the digital camera 100.

Internal components of the digital camera 100 include at least a camera processor 204, a photosensor 206, a memory storage interface 208 and a memory 210. Memory 210 further includes regions allocated for the data management logic 212, the camera image data region 214, the image display control logic 216, the security file 218, and the card key security system 220. An alternative embodiment of digital camera 100 according to the present invention includes a security timer 222, described in greater detail below.

Digital camera 100 creates security file 218 by copying information from card key 150. Accordingly, memory module unit 140, having card key 150, is coupled to digital camera 100. Camera processor 204 retrieves the card key 150, via connection 224, and saves the card key into the security file 218 residing in memory element 210, via connection 226.

In another embodiment, digital camera 100 retrieves backup card key 128 from personal computer 120. Thus, when digital camera 100 is coupled to personal computer 120, backup card key 128 is received at plug-in interface unit 112, and is then communicated to camera processor 204 via connection 228.

In one embodiment, the card key 150 is only created from information provided to a single designated device, such as the digital camera 100 owner's personal computer. Thus, a thief, or a person who buys digital camera 100 from the thief, is not able to create card key 150. Accordingly, the digital camera remains disabled according to the present invention.

The digital camera system can also create security file 218 by the same process by which card key 150 is created. The user may be prompted to create security file 218 upon first use of digital camera 100. In other embodiments, the user may be prompted to create or replace security file 218 upon activation of card key security system 220. In another embodiment, the user may be required to provide existing card key 150 if the user wishes to replace security file 218.

The card key security system 220 in accordance with the present invention can be implemented in software (e.g., firmware), hardware, or a combination thereof. In one embodiment, card key security system 220 is implemented in software, as an executable program, and is executed by camera processor 204. Camera processor 204 is a suitable hardware device for executing software, particularly that stored in memory element 210. The camera processor 204 can be any suitable custom-made or commercially available processor

The memory element 210 can include any one or combination of volatile memory elements (e.g., random access memory (RAM, such as DRAM, SRAM, SDRAM, etc.) and nonvolatile memory elements (e.g., FLASH, ROM, hard drive, tape, CDROM, etc.). Moreover, memory element 210 may incorporate electronic, magnetic, optical, and/or other types of storage media. Note that memory element 210 can have a distributed architecture, where various components are situated remote from one another, but can be accessed by camera processor 204.

The software in memory element 210 may include one or more separate programs, each of which comprises an ordered listing of executable instructions for implementing logical functions. In the example of FIG. 1, the software in memory element 210 includes card key security system 220 in accordance with the present invention and data management logic 212. Data management logic 212, in one embodiment, controls the execution of other computer programs, such as card key security system 220, and provides scheduling, input-output control, file and data management, memory management, and communication control, and related services.

In one embodiment, card key security system 220 is a source program, executable program (object code), script, or any other entity comprising a set of instructions to be performed. When a source program, then the program is translated via a compiler, assembler, interpreter, or the like, which may or may not be included within memory element 210, so as to operate properly in connection with data management logic 212. Furthermore, card key security system 220 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In one embodiment, card key security system 220 is implemented in the C or C++ language.

When digital camera 100 is in operation, camera processor 204 is configured to execute software stored within memory element 210, to communicate data to and from memory element 210, and to generally control operations of digital camera 100 pursuant to the software. Card key security system 220 and data management logic 212, in whole or in part, are read and then executed by camera processor 204.

When card key security system 220 is implemented in software, as is shown in FIG. 1, card key security system 220 can be stored on any suitable computer readable medium for use by or in connection with any computer related system or method. In the context of this document, a computer readable medium is an electronic, magnetic, optical, or other physical device or means that can contain or store a computer program for use by or in connection with a computer related system or method. The card key security system 220 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic, compact flash card, secure digital card, or the like), a flash memory, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where card key security system 220 is implemented in hardware, the card key security system 220 can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One embodiment of digital camera 100 includes security timer 222. As described in greater detail below, security timer 222 times a predefined time period such that after activation, digital camera 100 is activated for the time period. This time period is at least sufficient for the process of comparing the security file 218 with the card key 150 (FIG. 1). Security timer 222, in one embodiment, is a physical device configured to time the above-described time period. Thus, a suitable signal is provided to camera processor 204, via connection 230, indicating the timing of the time period.

In one embodiment, the above-described time period is fixed. In yet another embodiment, the time period is adjustable. Accordingly, a time period adjuster 232, coupled to security timer 222 via connection 234, is provided so that the user can adjust the time period. Time period adjuster 232 may be any suitable physical device such as, but not limited to, a dial, one or more touch-sensitive pushbuttons that increment the time, or a touch sensitive display screen. In another embodiment, software is provided as a part of the card key security system 220 such that the time period is adjustable. Accordingly, the time period is adjusted electronically by providing a suitable control signal to security timer 222. In yet another embodiment, time period adjuster 232 is coupled to processor 204 or to another suitable component. In another embodiment, security timer 222 is implemented as software included as part of the card key security system 220. Thus, internal clocks within digital camera 100, such as a clock residing in the camera processor 204, are employed to time the above-described time period.

In accordance with the present invention employing security timer 222, after the card key security system 220 has compared the security file 218 with the card key 150, digital camera is allowed to operate. Thus, images captured to photosensor 206 are communicated to the camera processor 204, via connection 236.

If digital camera 100 is configured to save captured images in the camera image data region 214, camera processor 204 stores the captured images into the camera image data region 214. In an embodiment of a digital camera that employs image memory region 152 residing in the memory module unit 140, the captured image is communicated and saved into the image memory region 152, via connection 224. In some embodiments, memory storage interface 208 is included along connection 224 so that the captured image is converted to data suitable for storage in image memory region 152.

In one embodiment, digital camera 100 associates a time or another suitable time-based marker with security file 218 so that security file 218 can be distinguished from card key 150. Nonlimiting examples of a time or other suitable time-based marker include a number of minutes, a number of hours, a number of days, a number of weeks, a specific date and/or a specific time, or the like. Digital camera 100 monitors the specified time period and/or marker, and at the end of the time period and/or marker, prompts the user of digital camera 100 to provide the card key 150. Accordingly, the user must provide the card key 150 if digital camera 100 is to remain enabled. Failure to provide the card key 150 causes the card key security system 220 to disable digital camera 100.

For example, but not limited to, the owner of digital camera 100 may go on a ten day vacation, from January 1 through January 10. The owner may specify a ten day (or more) period that digital camera 100 is to remain operational by setting the security timer 222, or by specifying a time or another suitable time-based marker with security file 218. At the end of the ten day period, a user of digital camera 100 will have to provide the card key 150 for digital camera 100 to remain operational. Thus, if digital camera 100 is stolen, digital camera 100 becomes disabled after the ten day period. Alternatively, the owner may specify that digital camera 100 is to prompt the user for card key 150 on, or just after, January 10. Thus, if digital camera 100 is stolen, digital camera 100 becomes disabled after the specified date of January 10.

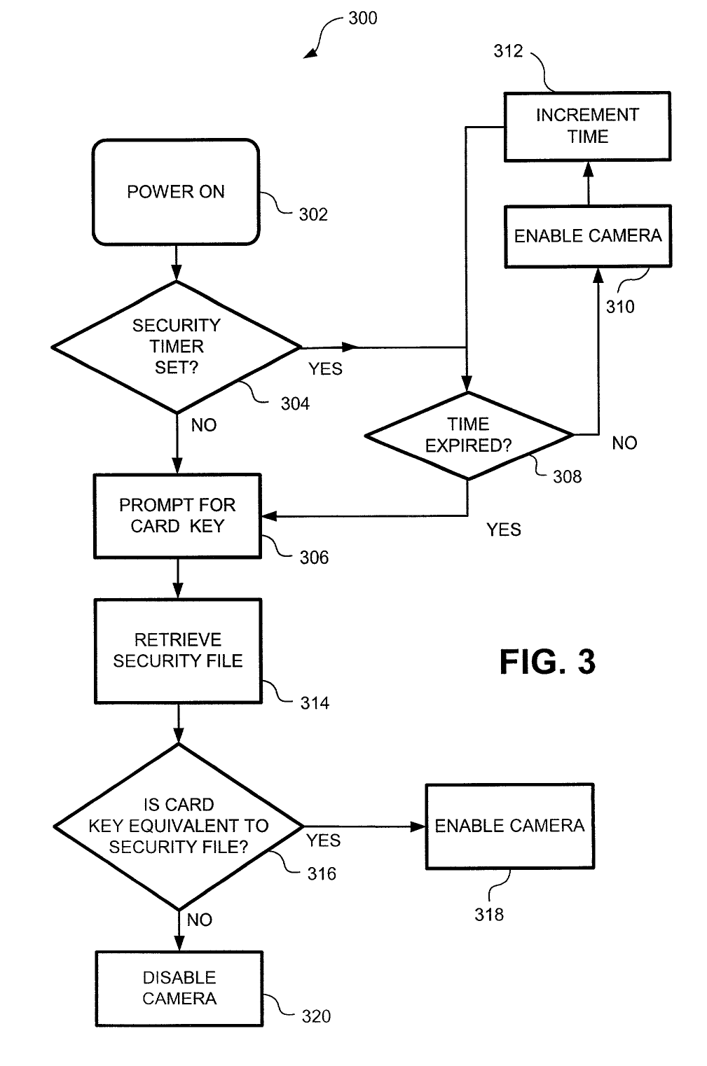

FIG. 3 is a flowchart 300 of an embodiment of card key security system 220 (FIG. 2). The flowchart 300 shows the architecture, functionality, and operation of a possible implementation of card key security system 220. In this regard, each block represents a module, segment, or portion of code, which comprises one or more executable instructions for implementing the specified logical function(s). It should also be noted that in some alternative implementations, the functions noted in the blocks may occur out of the order noted in flowchart 300. For example, two blocks shown in succession in flowchart 300 may in fact be executed substantially concurrently or the blocks may sometimes be executed in the reverse order, depending upon the functionality involved, as will be further clarified hereinbelow.

At block 302, the card key security system 220 is activated. In one embodiment, card key security system 220 is activated whenever digital camera 100 is turned on. In another embodiment, card key security system 220 is activated when a user manually turns on card key security system 220. The user may turn on card key security system 220 via activation logic associated with data management logic 212. The activation may be via a menu system shown on display 116.

At block 304, card key security system 220 determines whether security timer 222 has been set. If security timer 222 at block 304 is set (the YES condition), the card key security system 220 allows digital camera 100 to operate for a predefined period of time. At the end of the time period the user is required to provide card key 150. Accordingly, security timer 222 keeps track of this period of time when activated. If the card key security system 252 determines that security timer 222 has not been set, the process proceeds to block 306. That is, if the security timer 222 has not been set (the NO condition), the digital camera 100 immediately prompts the user for the card key 150.

If the card key security system 220 determines security timer 222 has been set (the YES condition), the process proceeds to block 308. At block 308, the card key security system 220 determines whether the time set on the security timer has expired. If the time has not expired (the NO condition), the process proceeds to block 310 and enables digital camera 100. Then, the process proceeds to block 312 to increment time. The logical loop of blocks 308, 310 and 312 is repeated until the expiration of the time period. Upon expiration of the time period, the process proceeds to block 306.

In block 306, the card key security system 220 prompts the user for card key 150. Card key 150 resides in the memory module unit 140. Thus, the memory module unit is coupled to the digital camera, as described above, so that the card key 150 is provided. At block 314, the card key security system 220 retrieves a card key 150 from the memory module unit 140, via memory unit interface 110.

Alternatively, the backup card key 128 associated with the personal computer 120 and stored in memory element 124 may be provided. Accordingly, the digital camera 100 is coupled to the personal computer 120 as described above. The backup card key 128 is communicated from personal computer 120 to the camera processor 204.

At block 316, the card key security system 220 determines whether security file 218 is equivalent to card key 150, or alternatively, to backup card key 128. Any suitable comparison algorithms may perform the comparison. If the card key 150 is equivalent to or corresponds to the security file 218 (the YES condition), the process proceeds to block 318 and enables digital camera 100. If the card key security system 220 determines the card key 150 is not equivalent to or does not correspond to the security file 218 (the NO condition), the process proceeds to block 320. At block 320, the card key security system 220 disables the digital camera 100.

In another embodiment, the card key security system 220 may be disabled via the owner's personal computer. Digital camera 100 is coupled to personal computer 120, via connection 130, as described above. A suitable signal is provided to digital camera 100 over connection 130 such that the card key security system 220 recognizes that it is not to activate. Accordingly, digital camera 100 will not be disabled in the absence of card key 150. Alternatively, a suitable signal is provided to memory module unit 140. The suitable signal, which may be stored as a special card key 150 or stored elsewhere in memory module unit 140, is received by digital camera 100 when memory module unit 140 is coupled to memory unit interface 110.

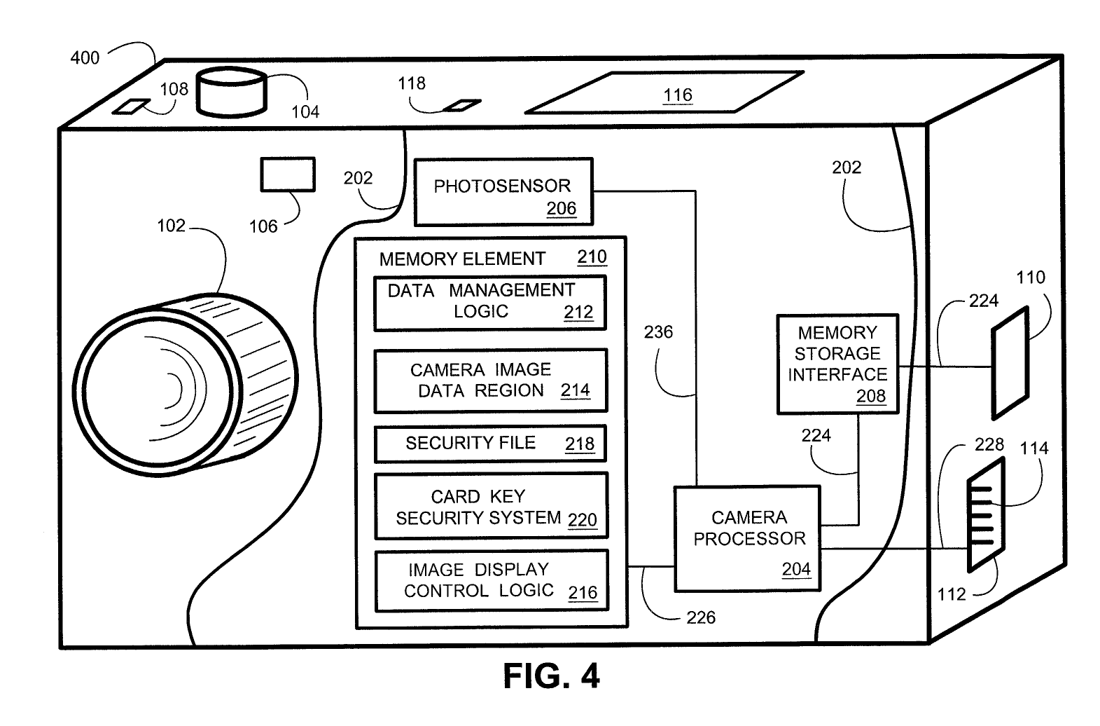

FIG. 4 is a block diagram of an alternative embodiment of the card key security system 220 according to the present invention implemented in digital camera 400, including memory element 210 storing card key security system 220 and security file 218. Digital camera 400 does not use a security timer 222 (FIG. 2) or a security timer logic. Upon activation of digital camera 400, the digital camera must be coupled to memory module unit 140 having card key 150, as described above. Or, digital camera 400 must be coupled to personal computer 120 having backup card key 128, as described above. If security file 218 corresponds to or is equivalent to card key 150 (or backup card key 128), the card key security system 220 enables the camera 400. If the card key security system 220 determines that security file 218 is not equivalent to card key 150 (or backup card key 128), the card key security system 220 disables the camera 400.

Another embodiment of card key security system 220 includes logic for enabling digital camera 100 even in the absence of the security file 218 For example, digital camera 100, in one embodiment, is disabled when first obtained from the manufacturer, distributor or re-seller. The authorized user, such as a bonafide purchaser, loads a special key into the memory element 124 of personal computer 120. Such a special key may initially reside in the backup card key 128 for convenience or in another suitable location in the memory element 124. The special key may be permanent or temporary. If temporary, the special key is replaced when the backup key is defined as described above.

When the user initially uses the digital camera 100, the special key is received over the connection 130 if the digital camera 100 is coupled to the personal computer 120. Alternatively, the special key may be placed into the memory module unit 140 as described above. Accordingly, the embodiment allows the digital camera 100 to be initially activated, and a new card key security system 220 created as described above. Furthermore, if the card key 150 is lost or otherwise destroyed, the digital camera 100 can be reactivated such that a new and/or replacement card key 150 is defined.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system for preventing unauthorized use of an electronic device, comprising:
a security file corresponding to a predefined security code;
a memory residing in the electronic device and configured to store the security file;
a card key, the card key corresponding to the predefined security code;
a processor configured to compare the card key with the security file, and further configured to enable use of the electronic device only if the security file corresponds to the card key; and
a security timer configured to time a period of time such that the processor compares the card key with the security file after the time period has elapsed.

2. The system of claim 1, wherein the card key resides in a portable memory module configured to couple to the electronic device and further configured to communicate the card key to the processor.

3. The system of claim 1, wherein the card key is a backup card key and resides in a second memory, the second memory residing in a computer such that the card key is communicated from the second memory to the processor.

4. The system of claim 3, wherein the electronic device comprises at least one selected from a group consisting of a digital camera, a personal computer, a laptop computer and a personal digital assistant.

5. The system of claim 3, further comprising a means for prompting a user to communicate the card key to the electronic device.

6. The system of claim 1, wherein the security timer is a hardware component coupled to the processor and configured to communicate a signal to the processor indicating that the time period has elapsed.

7. The system of claim 1, further comprising a unit of memory configured to store the security timer as logic such that the processor executes the security timer logic to time the time period.

8. The system of claim 1, further comprising a time adjuster configured to adjust the period of time timed by the security timer.

9. The system of claim 1, wherein the time adjuster is at least one selected from a group consisting of at least one touch-sensitive button, at least one pushbutton, a touch pad display and a menu displayed on a display.

10. A method for providing security to an electronic device, the method comprising the steps of:
receiving a card key, the card key corresponding to a predefined security code;
receiving a security key residing in a unit of memory within the electronic device, the security key corresponding to the predefined security code;
comparing the card key with the security key;
enabling the use of the electronic device only if the card key corresponds to the security key; and
timing a time period such that the steps of receiving, comparing and enabling are performed at the conclusion of the time period.

11. The method of claim 10, further comprising the step of disabling the electronic device when the card key does not correspond to the security key.

12. The method of claim 10, wherein the electronic device comprises at least one selected from a group consisting of a digital camera, a personal computer, a laptop computer and a personal digital assistant.

13. The method of claim 10, further comprising the step of prompting a user to communicate the card key to the electronic device.

14. The method of claim 10, wherein the step of timing a time period further includes the steps of:
communicating the activation of the electronic device to a security timer; and
communicating the end of timing period to a processor such that the processor performs the steps of receiving, comparing and enabling.

15. The method of claim 10, wherein the step of timing further includes the steps of:
executing a security timer logic residing in a second unit of memory with a processor; and
beginning the steps of receiving, comparing and enabling when the time period has elapsed.

16. The method of claim 10, further comprising the step of adjusting the time period.

17. A program for preventing the unauthorized use of electronic equipment, the program comprising:
logic configured to prompt a user to provide a card key, the card key corresponding to a predefined password;
logic configured to retrieve the card key from a first memory;
logic configured to retrieve the security file from a second memory residing in the electronic equipment, the security file corresponding to the predefined password;
logic configured to determine whether the card key corresponds to the security file; and
logic configured to enable the use of the digital camera only when the card key corresponds to the security file.

18. The program of claim 17, further comprising:
logic configured to start a timer; and
logic configured to determine whether a predefined time period of the timer has expired such that the logic configured to determine whether the card key corresponds to the security file is executed when the predefined time period has elapsed.

19. The program of claim 17, further comprising logic configured to time a period of time such that the logic configured to enable the use of the digital camera is executed when the predefined time period has elapsed.

20. The program of claim 17, further comprising logic configured to receive a time adjustment communication such that the predefined time period is adjusted.

21. A system for preventing unauthorized use of an electronic device, comprising:
a security file corresponding to a predefined security code;
a memory residing in the electronic device and configured to store the security file;
a portable memory module having a card key, the card key corresponding to the predefined security code, and the portable memory module configured to store additional information received from the electronic device; and
a processor configured to compare the card key with the security file, and further configured to enable use of the electronic device only if the security file corresponds to the card key.

22. The system of claim 21, wherein the portable memory module is configured to couple to the electronic device and further configured to communicate the card key to the processor.

23. The system of claim 22, wherein the additional information residing in the portable memory module is information corresponding to a captured image

24. The system of claim 22, further comprising a security timer configured to time a period of time such that the processor compares the card key with the security file after the time period has elapsed.

25. The system of claim 24, wherein the security timer is a hardware component coupled to the processor and configured to communicate a signal to the processor indicating that the time period has elapsed.

26. The system of claim 24, further comprising a unit of memory configured to store the security timer as logic such that the processor executes the security timer logic to time the time period.

27. The system of claim 24, further comprising a time adjuster configured to adjust the period of time timed by the security timer.

28. The system of claim 24, wherein the time adjuster is at least one selected from a group consisting of at least one touch-sensitive button, at least one pushbutton, a touch pad display and a menu displayed on a display.

29. A method for providing security to an electronic device, the method comprising the steps of:
receiving a portable memory module, the portable memory module having a card key corresponding to a predefined security code, and further configured to store additional information received from the electronic device;
communicating the card key from the portable memory module to the electronic device;
receiving a security key residing in a unit of memory within the electronic device, the security key corresponding to the predefined security code;
comparing the card key with the security key; and
enabling the use of the electronic device only if the card key corresponds to the security key.

30. The method of claim 29, further comprising the step of disabling the electronic device when the card key does not correspond to the security key.

31. The method of claim 29, wherein the electronic device comprises at least one selected from a group consisting of a digital camera, a personal computer, a laptop computer and a personal digital assistant.

32. The method of claim 29, further comprising the step of timing a time period such that the steps of receiving, comparing and enabling are performed at the conclusion of the time period.

33. The method of claim 32, wherein the step of timing the time period further includes the steps of:
communicating activation of the electronic device to a security timer; and
communicating end of timing period to a processor such that the processor performs the steps of receiving, comparing and enabling.

34. The method of claim 32, wherein the step of timing further includes the steps of:
executing a security timer logic residing in a second unit of memory with a processor; and
beginning the steps of receiving, comparing and enabling when the time period has elapsed.

35. The method of claim 32, further comprising the step of adjusting the time period.

36. The method of claim 29, further comprising the step of prompting a user to communicate the card key to the electronic device.
